(19) United States
(12) Patent Application Publication
(10) Pub. No.: US 2003/0103671 A1
(43) Pub. Date: Jun. 5, 2003

(54) IMAGE PROCESSING APPARATUS AND METHOD

(76) Inventor: TAKAHIRO MATSUURA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/305,313

(22) Filed: May 5, 1999

(30) Foreign Application Priority Data
May 6, 1998 (JP) 10-123685

(51) Int. Cl. G06T 7/00; H04N 1/38; H04N 1/387

(52) U.S. Cl. 382/173; 382/168; 382/282

(57) ABSTRACT

When an image contains a frame image representing a white frame, highlight portions except the frame are influenced by the white color of the frame, and gradation is not appropriately corrected. Hence, no sufficient dynamic range for gradation can be obtained. To prevent this, a frame recognition section (8) detects a frame image contained in an input image. A highlight/shadow calculation section (6) and a white balance calculation section (7) generate correction information of an image portion other than the detected frame image. An image correction section (10) corrects gradation of the image portion other than the frame image on the basis of the generated correction information.

### BACKGROUND OF THE INVENTION

1. Field of the Invention

The present invention relates to an image processing apparatus and method and, more particularly, to an image processing apparatus for processing an image containing a frame image and a method therefor.

2. Description of the Related Art

For example, when gradation of an image is to be corrected, the entire image is corrected independently of whether a frame image (to be also simply referred to as a “frame” hereinafter) with an impression of, e.g., a frame is present in the image to be processed.

For this reason, when a white frame is contained in the image to be processed, highlight portions except the frame are influenced by the white color of the frame, and gradation is not appropriately corrected. Hence, no sufficient dynamic range for gradation can be obtained.

### SUMMARY OF THE INVENTION

The present invention has been made to solve the above problem, and has as its object to provide an image processing apparatus capable of appropriately processing an image containing a frame image and a method therefor.

In order to achieve the above object, according to a preferred aspect of the present invention, there is provided an image processing apparatus comprising: detection means for detecting an image area excluding a frame image contained in an input image; generation means for generating correction information of the detected image area; and correction means for correcting the image area on the basis of the generated correction information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the functional blocks (modules) of software according to an embodiment of the present invention;

FIG. 2 is a flow chart showing the operation of the first embodiment of the present invention;

FIG. 3 is a view for explaining data held by a parameter holding section;

FIG. 4 is a flow chart showing details of processing of a frame recognition section;

FIGS. 5A to 5D are views for explaining the criteria for determining whether a pixel partially constructs a frame;

FIGS. 6A and 6B are views for explaining data stored in an image information holding section;

FIG. 7 is a flow chart showing details of processing of an image identification section;

FIGS. 8A to 8H are views showing details of an image portion identification operation by the image identification section;

FIG. 9 is a flow chart showing details of processing of a highlight/shadow calculation section;

FIG. 10 is a graph showing a luminance histogram;

FIG. 11 is a flow chart showing details of processing of a white balance calculation section;

FIG. 12 is a flow chart showing details of processing of an image correction section;

FIG. 13 is a graph showing the characteristics of a look-up table prepared by the image correction section;

FIGS. 14A and 14B are views showing an image having a frame with gradation;

FIG. 15 is a flow chart showing the operation of the second embodiment of the present invention;

FIG. 16 is a flow chart showing details of processing of an image identification section;

FIGS. 17A to 17P are views for explaining an image portion detection operation;

FIGS. 18A to 18L are views for explaining an image portion detection operation; and

FIG. 19 is a block diagram showing the hardware arrangement of an image processing apparatus according to the present invention.

### DETAILED DESCRIPTION OF THE PREFERRED EMBODIMENTS

Preferred embodiments of the present invention will be described below in detail with reference to the accompanying drawings. An image processing apparatus of the present invention is realized by an apparatus having a hardware arrangement as shown in FIG. 19, for example, a computer apparatus such as a personal computer, or by supplying software (to be described later) to a dedicated computer apparatus.

Referring to FIG. 19, a CPU 2 of a computer apparatus 100 executes a program stored in a ROM 1 and a storage section 8 using a RAM 3 and the storage section 8 such as a hard disk as a work memory. This program includes at least an operating system (OS) and software (to be described later) for executing processing of the present invention.

Image data to be processed by the computer apparatus 100 is input from an input device such as a digital still camera 7 through an input interface (I/F) 6 and processed by the CPU 2. The processed image data is converted by the CPU 2 into a form and format according to an output device and sent to the output device such as a printer 11 through an output I/F 10. The input image data, output image data, and image data under processing may be stored in the storage section 8 or sent to a monitor 5 such as a CRT or an LCD through a video I/F 4 to display the image, as needed. These processing and operations are instructed by the user through a keyboard as an input device or a mouse as a pointing device connected to a keyboard I/F 9.

As the input and output I/Fs 6 and 10, SCSI or GPIB interfaces as general-purpose interfaces, parallel interfaces such as centronics, and serial interfaces such as RS232, RS422, IEEE1394, or USB (Universal Serial Bus) are used.

As the storage section 8, not only a hard disk but also a storage medium such as a magneto-optical disk (MO) or an optical disk including a digital video disk (DVD-RAM) can be used. As the device for inputting image data, a digital video camera, an image scanner, or a film scanner can be used in addition to the digital still camera. Image data can also be input from the above storage medium or through a communication medium. As the device for outputting image data, a printer such as a laser beam printer, an ink-jet printer, or a thermal printer, or a film recorder can be used. Processed image data may be stored in the above storage medium or sent to a communication medium.

First Embodiment

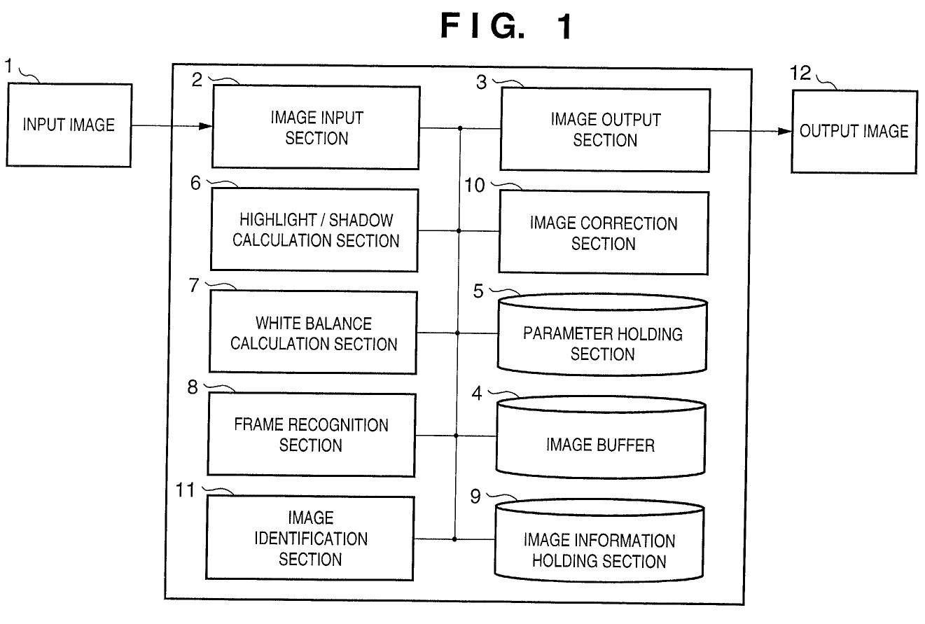

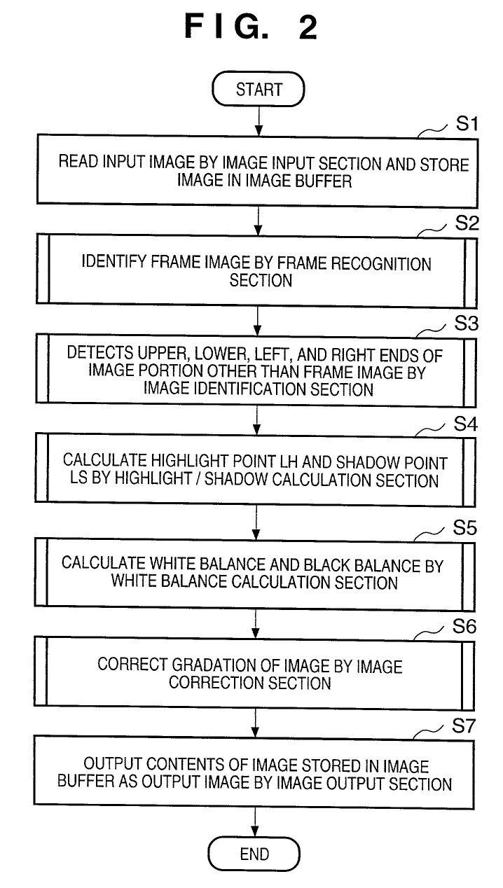

FIG. 1 is a view showing the functional blocks (modules) of software of the first embodiment. FIG. 2 is a flow chart showing the operation of the first embodiment. The operation of this embodiment will be described below in detail in units of functional blocks.

[Frame Recognition]

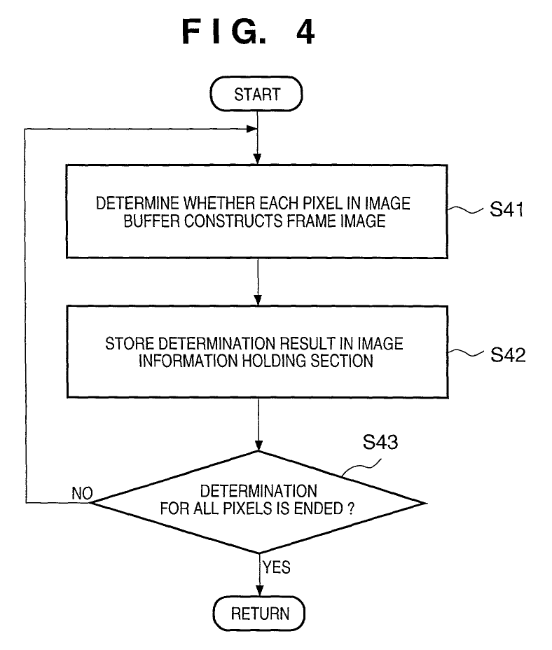

In step S1, an input image 1 is read by an image input section 2 and stored in an image buffer 4. In step S2, the image data buffered in the image buffer 4 is checked in units of pixels by a frame recognition section 8, whose processing is shown in FIG. 4 in detail. It is determined whether a pixel partially constructs a frame (step S41), and the determination result is stored in an image information holding section 9 (step S42) On the basis of determination in step S43, processing in steps S41 and S42 is repeated for all image data buffered in the image buffer 4, and then, the flow advances to step S3.

Determination in step S41 is done by comparing the color of a pixel of interest with the colors of eight pixels (adjacent pixels) adjacent to the pixel of interest. If a condition for recognizing a frame is satisfied, the pixel of interest is marked as part of a frame. If the condition is not satisfied, the pixel of interest is marked not to construct a frame.

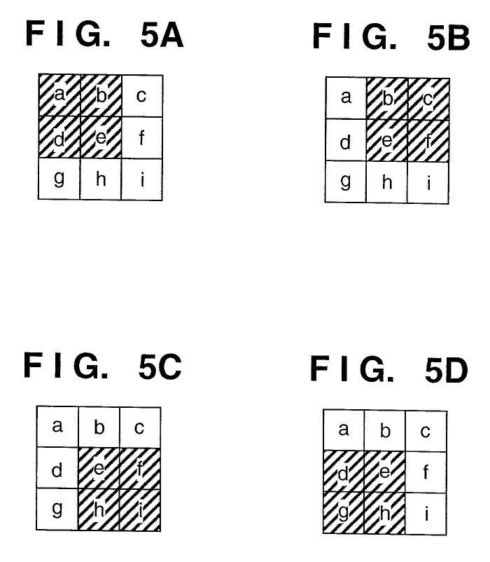

FIGS. 5A to 5D are views for explaining the criteria for determining whether a pixel partially constructs a frame. When any one of the following conditions is satisfied, a pixel e of interest is recognized as part of a frame.

(1) As shown in FIG. 5A, pixels a, b, d, and e have the same color.

(2) As shown in FIG. 5B, pixels b, c, e, and f have the same color.

(3) As shown in FIG. 5C, pixels e, f, h, and i have the same color.

(4) As shown in FIG. 5D, pixels d, e, g, and h have the same color.

The “same color” in the above conditions may be replaced with, e.g., “colors within a predetermined range”.

FIGS. 6A and 6B are views for explaining data stored in the image information holding section 9. The image information holding section 9 holds data of 1 bit/pixel (FIG. 6B) in correspondence with image data of 8 bits/pixel of each color (FIG. 6A). That is, the image information holding section 9 holds binary data with the same sizes as the vertical and horizontal sizes of an image stored in the image buffer 4.

[Image Identification]

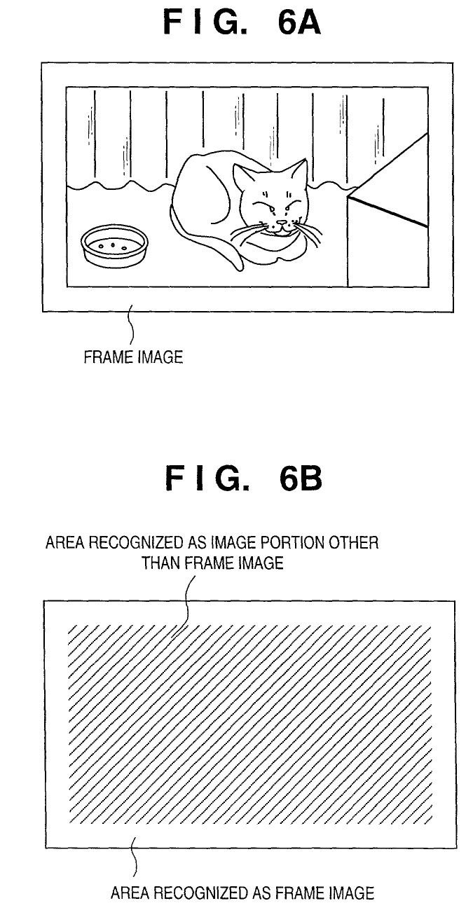

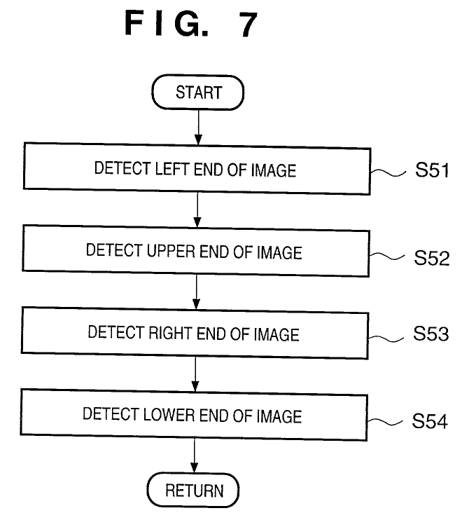

In step S3, an image portion, i.e., an image portion other than the frame is identified from the data stored in the image information holding section 9 by an image identification section 11, whose processing is shown in FIG. 7 in detail (steps S51 to S54). Information of the upper, lower, left, and right ends of the image portion as the identification result is stored in a parameter holding section 5. Terms “upper end”, “lower end”, “left end”, and “right end” will be described later in detail. Detection of an image portion except the frame will be described below. However, the frame portion can also be detected in accordance with almost the same procedure.

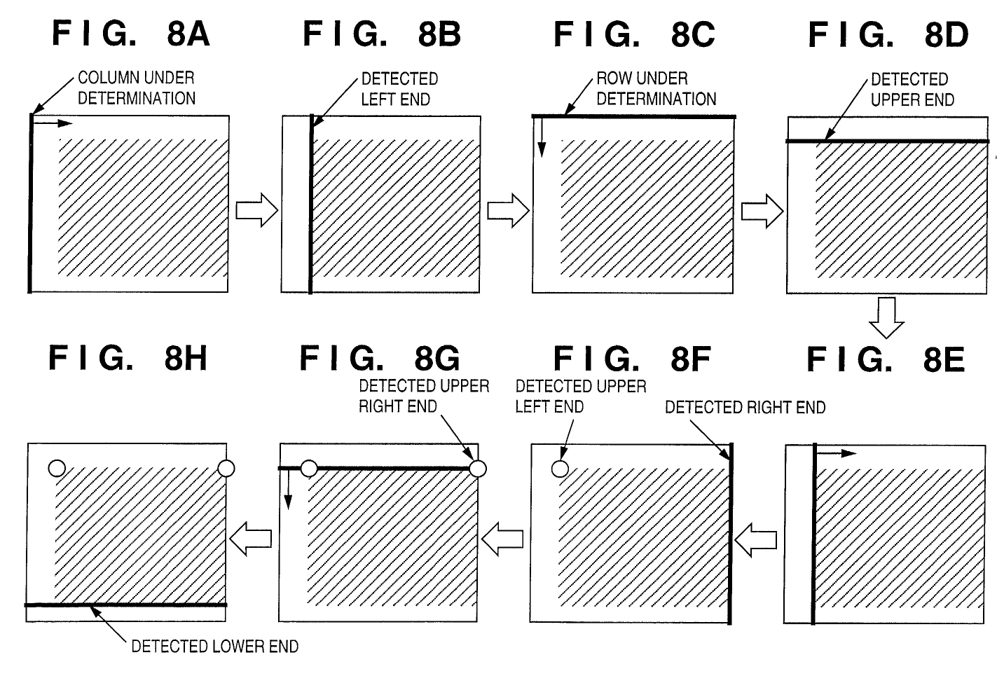

FIGS. 8A to 8H are views showing details of an image portion identification operation by the image identification section 11. In step S51, the left end of the image is detected. To do this, the image is checked in units of columns from the left to the right. The position of the first column containing a pixel marked not to construct a frame is detected as the left end (FIGS. 8A and 8B).

In step S52, the upper end of the image is detected. The image is checked in units of rows from the upper side to the lower side. The position of the first row containing a pixel marked not to construct a frame is detected as the upper end (FIGS. 8C and 8D).

In step S3, the right end of the image is detected. The image is checked in units of columns from the detected left end to the right. The position of a column on the immediately left side of a column in which all pixels are marked to construct a frame is detected as the right end. When the right end is not detected, i.e., a column in which all pixels are marked to construct a frame is not detected until the right end of the image, the position of the rightmost column of the image is set as the right end (FIGS. 8E and 8F).

In step S4, the lower end of the image is detected. The image is checked in units of rows from the detected upper end to the lower side. The position of a row on the immediately upper side of a row in which all pixels are marked to construct a frame is detected as the lower end. When the lower end is not detected, i.e., a row in which all pixels are marked to construct a frame is not detected until the lower end of the image, the position of the lowermost row of the image is set as the lower end (FIGS. 8G and 8H).

In the above description, a column or row having a pixel marked not to construct a frame or a column or row in which all pixels are marked to construct a frame is detected. However, in consideration of a case wherein an end of the frame tilts, curves, or undulates, a column or row having at least a predetermined number of pixels marked to construct a frame or at least a predetermined number of consecutive pixels marked to construct a frame may be detected.

[Calculation of Highlight Point and Shadow Point]

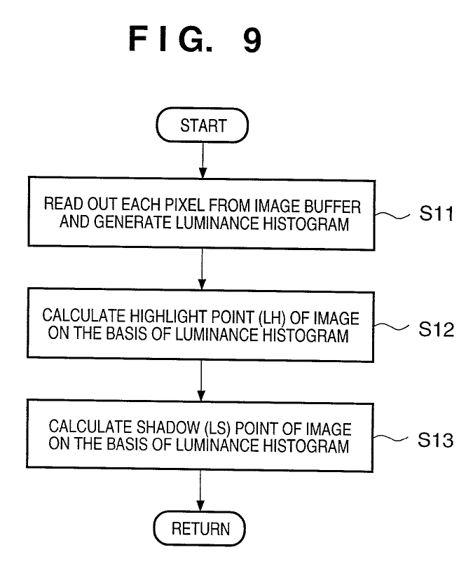

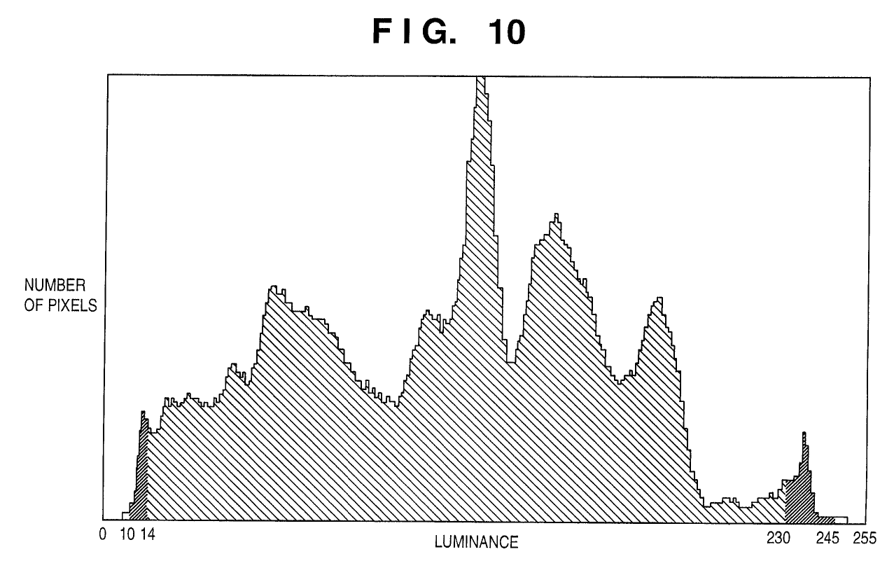

In step S4, a highlight point and a shadow point are calculated by a highlight/shadow calculation section 6, whose processing is shown in FIG. 9 in detail, on the basis of the information stored in the parameter holding section 5, and stored in the parameter holding section 5. More specifically, in step S1, image data of the image portion except the frame is read out from the image buffer 4, and a luminance histogram shown in FIG. 10 is generated. Next, on the basis of the generated histogram, a highlight point LH and a shadow point LS are calculated in steps S12 and S13. The highlight point LH is the minimum luminance value in the highlight area. The shadow point LS is the maximum luminance value in the shadow area.

In the luminance histogram shown in FIG. 10, since luminances in the highlight area (99% to 100%) are 230 to 255, the highlight point LH is 230. Additionally, since luminances in the shadow area (0% to 1%) are 0 to 14, the shadow point LS is 14.

[Calculation of White Balances]

In step S5, the white balances and black balances are calculated by a white balance calculation section 7, whose processing is shown in FIG. 11 in detail, on the basis of the information stored in the parameter holding section 5, and stored in the parameter holding section 5. More specifically, in steps S21 and S22, each pixel is read out from the image buffer 4, the average luminance value (white balance) of pixels with luminances falling between the highlight point LH and a corrected highlight point HP is calculated for each of the R, G, and B colors, and the average luminance value (black balance) of pixels with luminances falling between a corrected shadow point SP and the shadow point LS is calculated for each of the R, G, and B colors.

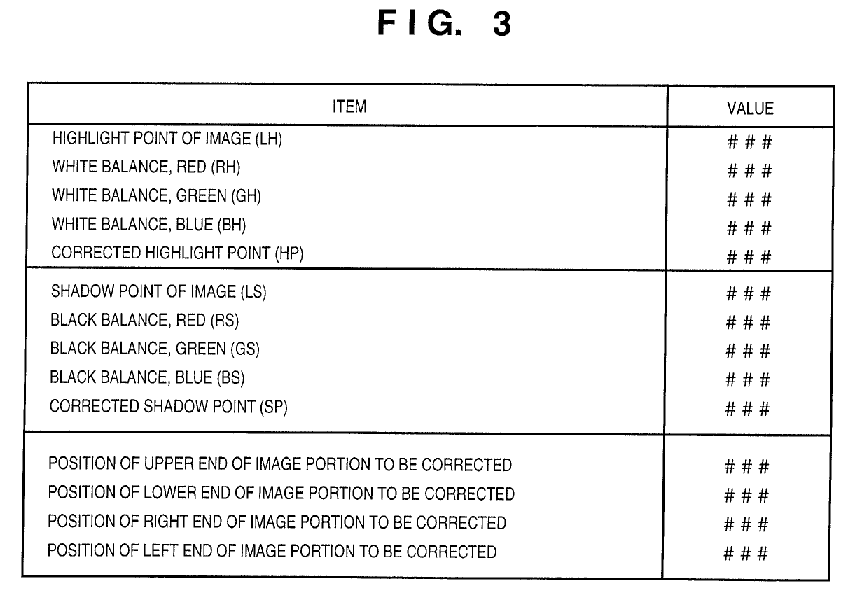

Referring to FIG. 10, the average luminance of pixels with luminances falling within the range from LH=230 to HP=245 is calculated as the white balance for each of the R, G, and B colors, and the average luminance of pixels with luminances falling within the range from SP=10 to LS=14 is calculated as the black balance for each of the R, G, and B colors. These results are stored in corresponding registers RH, GH, BH, RS, GS, and BS in the parameter holding section 5 (FIG. 3).

[Image Correction]

In step S6, gradation of the image is corrected by an image correction section 10, whose processing is shown in FIG. 12 in detail, on the basis of the information stored in the parameter holding section 5, and the correction result is written in the image buffer 4. More specifically, a look-up table for gradation correction is prepared on the basis of the white balances and black balances stored in the parameter holding section 5 (step S31). Image data read out from the image buffer 4 in units of pixels is subjected to gradation correction using the look-up table. The corrected image data are written in the image buffer 4 (step S32).

FIG. 13 is a graph showing the characteristics of the look-up table. The look-up table is prepared on the basis of the white balances RH, GH, BH, and white point LH, and the black balances RS, GS, and BS, and black point LS. In the example shown in FIG. 13, the gamma correction level for the highlight portion increases in the order of green, blue, and red. In this way, by emphasizing green and blue with respect to red, so-called color fog of a bluish (fogged with blue) image can be corrected.

[Image Output]

Finally, in step S7, the image which has undergone gradation correction and buffered in the image buffer 4 is output by an image output section 3 as an output image 12.

[Parameter Holding Section]

FIG. 3 is a view showing data held by the parameter holding section 5. In the initial state, appropriate values are stored as the corrected highlight point HP and corrected shadow point SP.

[Recognition of Frame with Gradation]

When the following conditions are set for determination in step S41 in consideration of a frame with gradation as shown in FIG. 14A, the pixel e of interest can be recognized to construct a frame (FIG. 14B). To determine the following conditions, RGB image data is temporarily converted into HSB data or HSL data. This conversion technique is known and a detailed description thereof will be omitted.

(1) Pixels a, b, d, and e shown in FIG. 5A have the same hue, and the difference between the lightness and saturation has a predetermined value or less.

(2) Pixels b, c, e, and f shown in FIG. 5B have the same hue, and the difference between the lightness and saturation has a predetermined value or less.

(3) Pixels e, f, h, and i shown in FIG. 5C have the same hue, and the difference between the lightness and saturation has a predetermined value or less.

(4) Pixels d, e, g, and h shown in FIG. 5D have the same hue, and the difference between the lightness and saturation has a predetermined value or less.

Second Embodiment

In the first embodiment, gradation correction when one image portion (e.g., a photograph) is contained in one image has been described. However, when frame recognition of the present invention is applied, even when a plurality of image portions are contained in one image, gradation correction can be appropriately performed for each image portion. The second embodiment in which, for example, two image portions are recognized, and gradation correction is performed for each of the two recognized image portions will be described below. An image portion detection method to be described below can be applied to detect not only two image portions but also three or more image portions, as a matter of course.

FIG. 15 is a flow chart showing the operation of the second embodiment. The operation of the second embodiment will be described below in detail in units of functional blocks.

[Frame Recognition]

In step S61, an input image 1 is read by an image input section 2 and stored in an image buffer 4. In step S62, the image data buffered in the image buffer 4 is checked in units of pixels by a frame recognition section 8. It is determined whether a pixel partially constructs a frame (step S41), and the determination result is stored in an image information holding section 9 (step S42). On the basis of determination in step S43, processing in steps S41 and S42 is repeated for all image data buffered in the image buffer 4, and then, the flow advances to step S63.

[Image Identification]

In step S63, an image portion, i.e., an image portion other than the frame is identified from the data stored in the image information holding section 9 by an image identification section 11, whose processing is shown in FIG. 16 in detail (steps S71 to S76). Information of the upper, lower, left, and right ends of the image portion as the identification result is stored in a parameter holding section 5.

The operation of the image identification section 11 will be described in detail. In step S71, the left end of the image is detected. To do this, the image is checked in units of columns from the left. The position of a column containing a pixel marked not to construct a frame is detected as the left end. Subsequently, in step S72, it is determined whether the left end is detected. If NO in step S72, detection is ended. If YES in step S72, the flow advances to step S73.

In step S73, the upper end of the image is detected. The image is checked in units of rows from a row containing a pixel marked not to construct a frame and located at the uppermost portion of the column at the left end detected in step S71 to the upper side. A row having at least a predetermined number of consecutive pixels marked to construct a frame is detected. The position of a low immediately below the row is detected as the upper end.

In step S74, the values of the detected left and upper ends are set as the initial values of the right and lower ends of the image. In step S75, the right end of the image is detected. The image is checked from the position of the right end initially set in step S74 to the right in units of columns. A column having at least a predetermined number of consecutive pixels marked to construct a frame is detected. The position of a column immediately on the left side of the column is detected as the right end.

Instep S76, the position of the right end of the image is compared with that of the lower end. Processing advances on the basis of the comparison result.

(1) When the right end is on the lower left side of the lower end, processing is ended.

(2) When the right end is on the upper side of the lower end, the flow returns to step S75.

(3) When the lower end is on the left side of the right end, the flow advances to step S77.

In step S77, the lower end of the image is detected. The image is checked from the current lower end position to the lower side in units of rows. A row having at least a predetermined number of consecutive pixels marked to construct a frame is detected. The position of a row immediately above the row is detected as the lower end.

When detection processing shown in FIG. 16 is ended, it is determined in step S64 whether the upper, lower, left, and right ends of the image are detected, i.e., an image portion is detected. If YES in step S64, information representing the upper, lower, left, and right ends of the image portion are stored in the parameter holding section 5, and the flow advances to step S65. If NO in step S64, i.e., when detection is ended, the flow advances to step S69, and the image which has undergone gradation correction and buffered in the image buffer 4 is output by an image output section 3 as an output image 12.

Steps S65 to S67 correspond to steps S4 to S6 in FIG. 2 and have substantially the same processing contents as described above, and a detailed description thereof will be omitted.

In step S68, information in the area of an image information holding section 9, which corresponds to the image portion which has undergone gradation correction, is marked again to construct a frame. After the information in the image information holding section 9 is updated, the flow returns to step S63 to detect the next image portion.

### EXAMPLE 1 OF IMAGE RECOGNITION

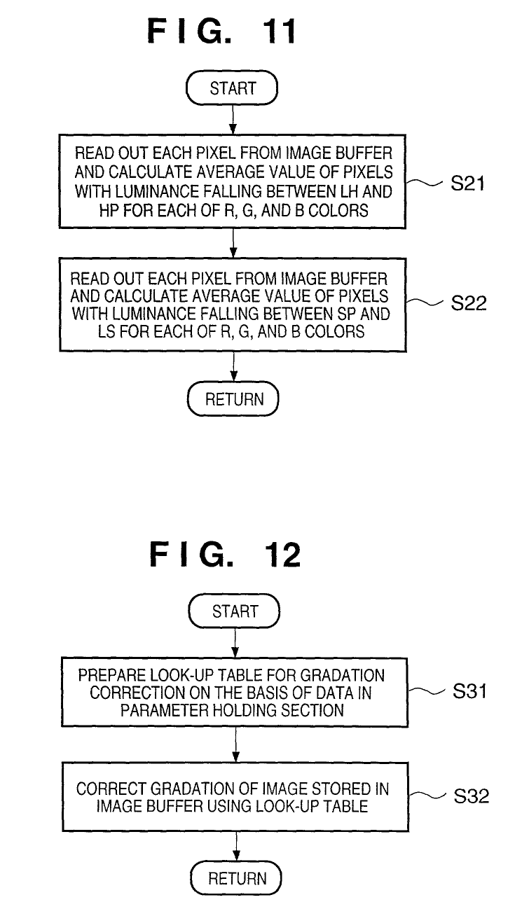

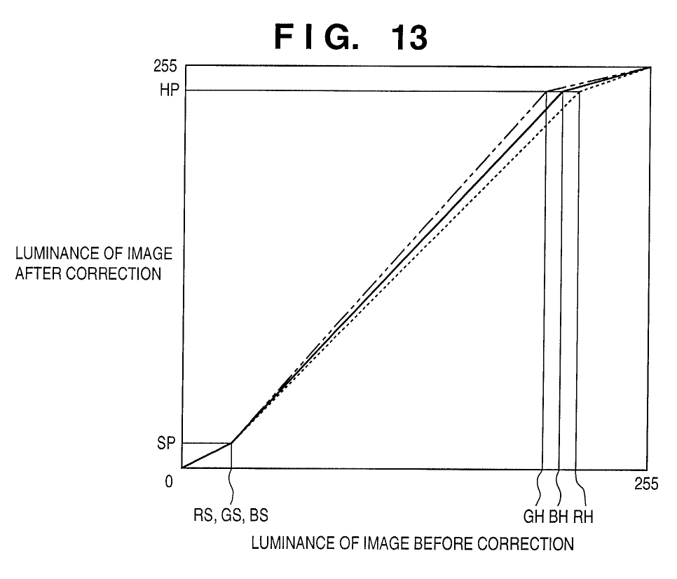

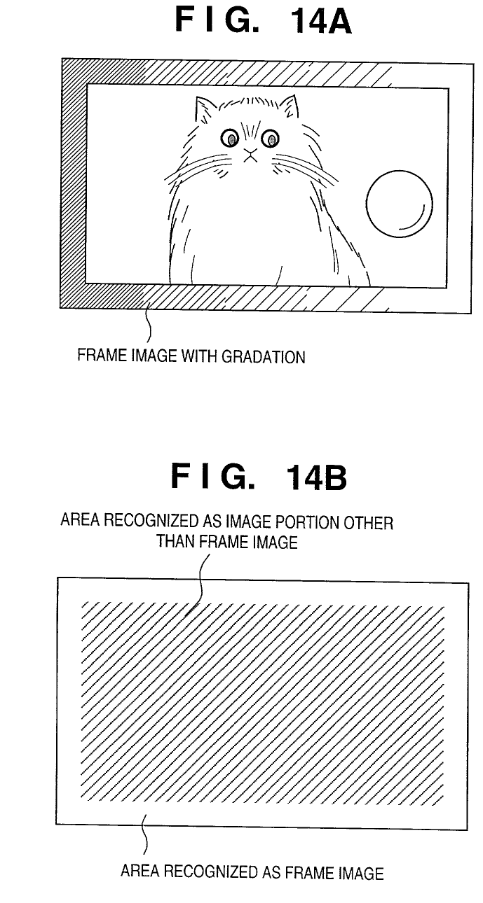

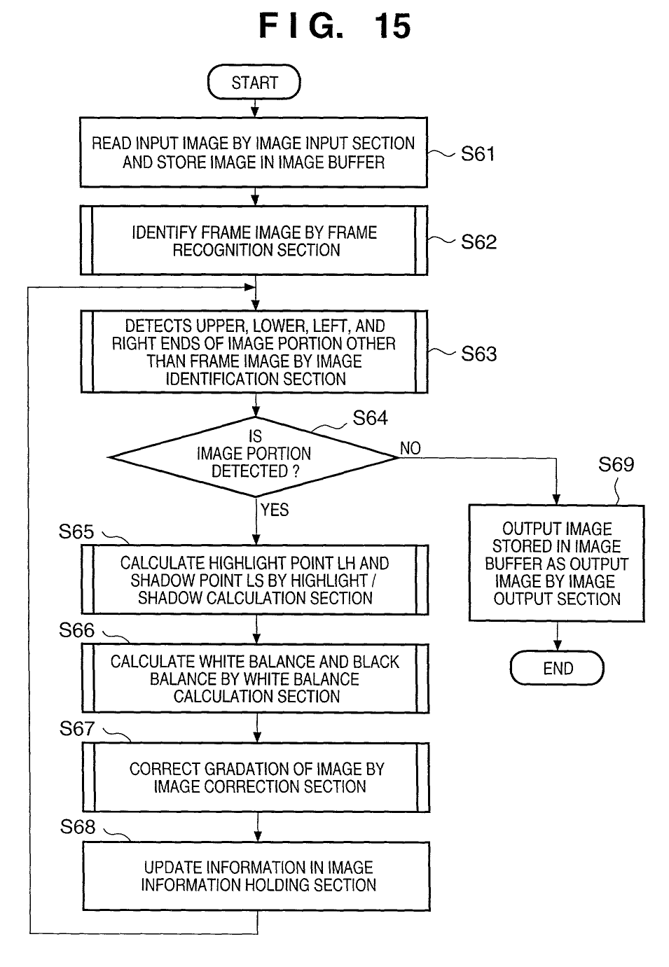

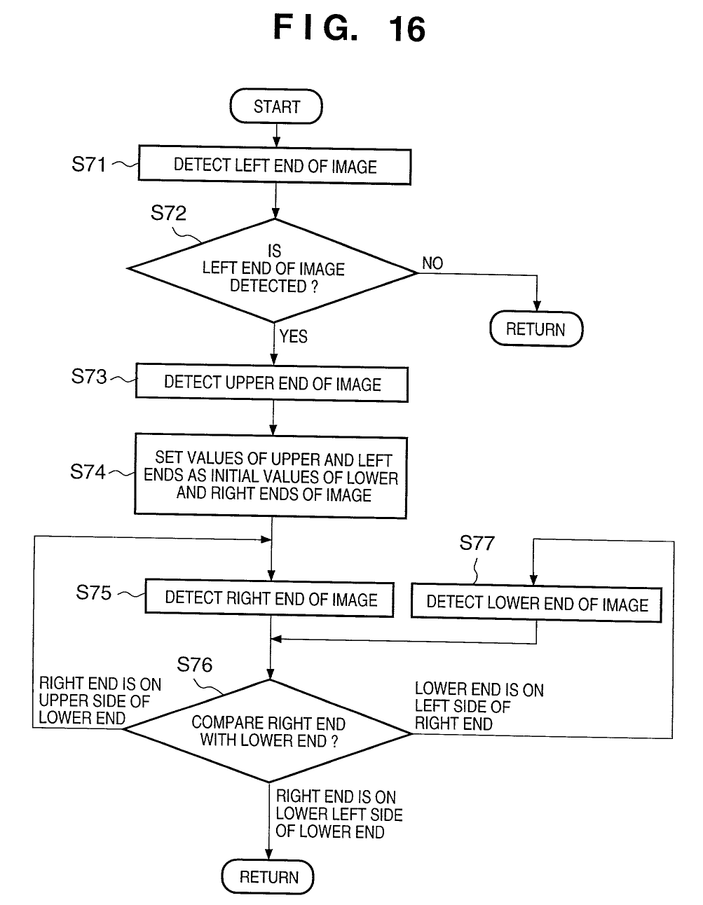

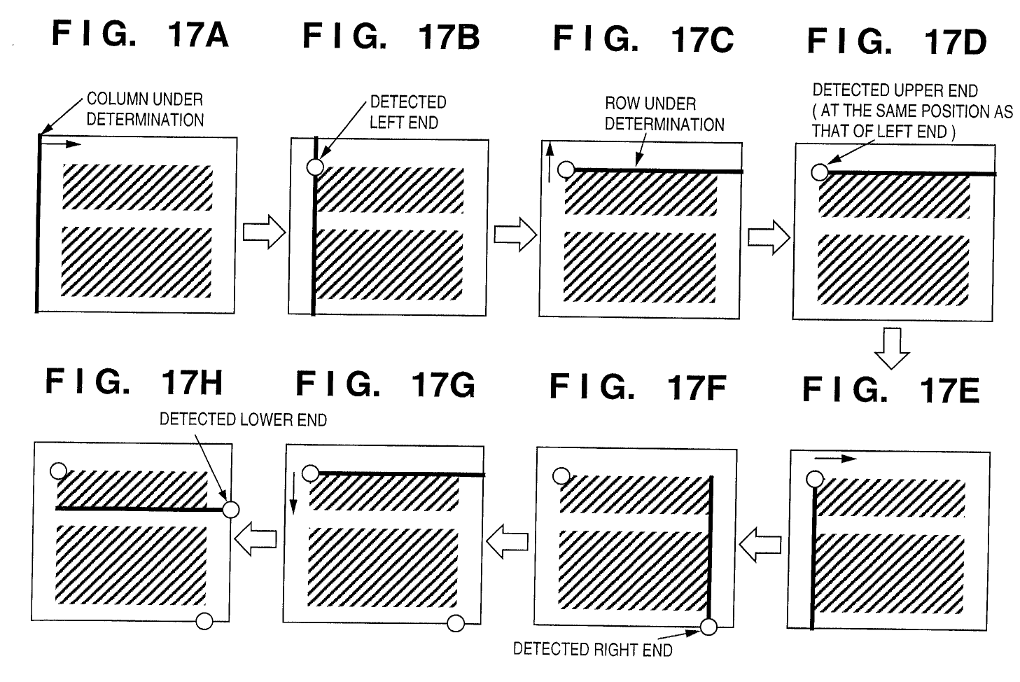

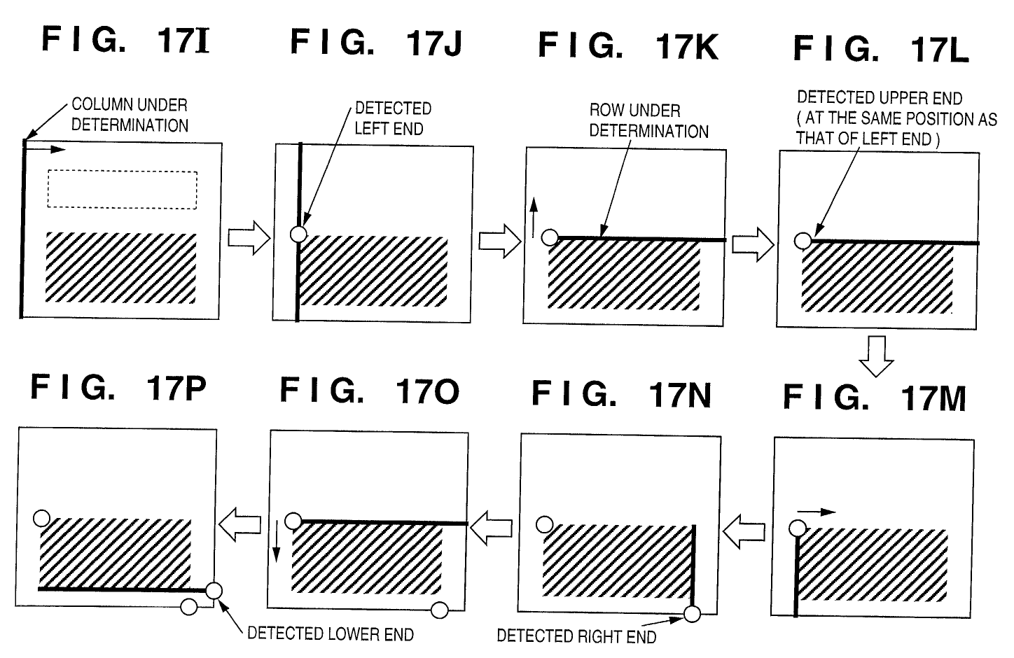

FIGS. 17A to 17P are views for explaining image recognition when one image contains two image portions.

At the time point of step S62, information as shown in FIG. 17A is stored in the image information holding section 9. Next, in step S71, a column containing a pixel determined not to construct a frame is searched for from the left in units of columns to detect the left end of the image (FIG. 17B). In step S73, on the right side of the detected left end, a row having at least a predetermined number of consecutive pixels marked to construct a frame is searched for to the upper side in units of rows to detect the upper end of the image (FIGS. 17C and 17D). In step S74, the same values as those of the left and upper ends are set as the initial values of the right and lower ends of the image.

In step S75, the right end of the image is detected. The image is checked from the position of the currently set right end of the image to the right in units of columns. The position of a column immediately on the left side of a column having at least a predetermined number of pixels marked to construct a frame is detected as the right end (FIGS. 17E and 17F).

In step S76, the position of the right end is compared with that of the lower end. In the example shown in FIGS. 17A to 17P, since the lower end is on the left side of the right end, the flow advances to step S77. In step S77, the lower end of the image is detected. The image is checked from the currently set lower end to the lower side in units of rows. The position of a row immediately above a row having at least a predetermined number of consecutive pixels marked to construct a frame is detected as the lower end (FIGS. 17G and 17H).

In step S76, again, the position of the right end is compared with that of the lower end. In this case, since the right end is on the lower left side of the lower end, the area of an image portion is determined, and the flow advances to step S64. Since the image portion is detected, steps S65 to S67 are executed on the basis of determination in step S64. The detected image portion is subjected to gradation correction. In step S68, the information in the image information holding section 9 is updated, and pixels corresponding to an area indicated by a broken line in FIG. 17I, i.e., the image portion which has undergone gradation correction, are marked again to construct a frame.

In step S63, again, another image portion is detected in accordance with the same procedure as described above (FIGS. 17I to 17P). Since the image portion is detected, steps S65 to S67 are executed on the basis of determination in step S64. The image portion is subjected to gradation correction. In step S68, the information in the image information holding section 9 is updated. After this, the flow returns to step S63 again. However, since only areas marked to construct frames are stored in the image information holding section 9, detection is ended on the basis of determination in step S72. After determination in step S64, an image which has undergone gradation correction is output in step S69.

### EXAMPLE 2 OF FRAME RECOGNITION

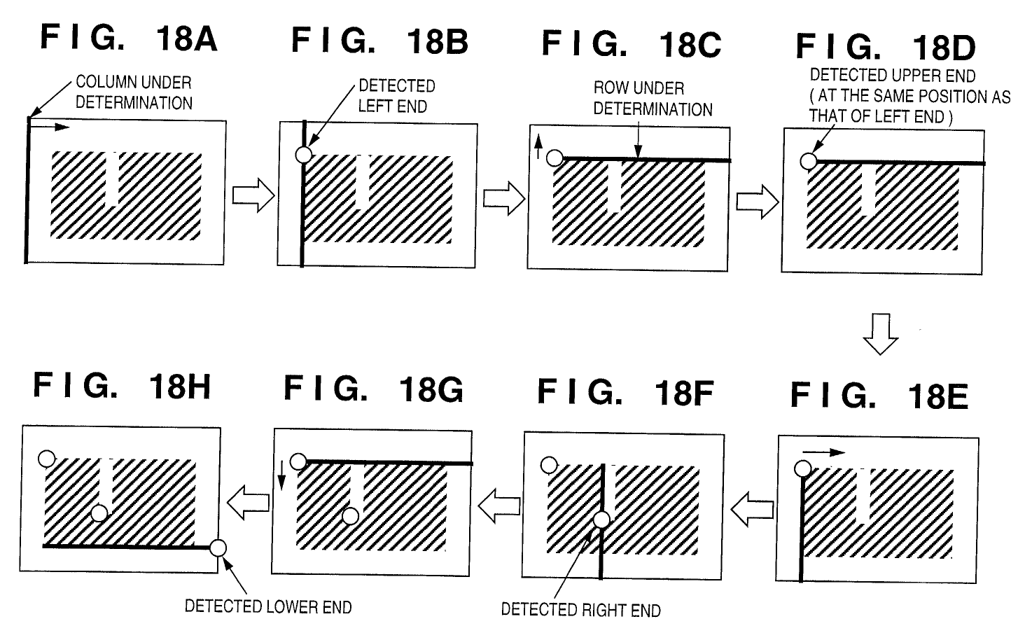

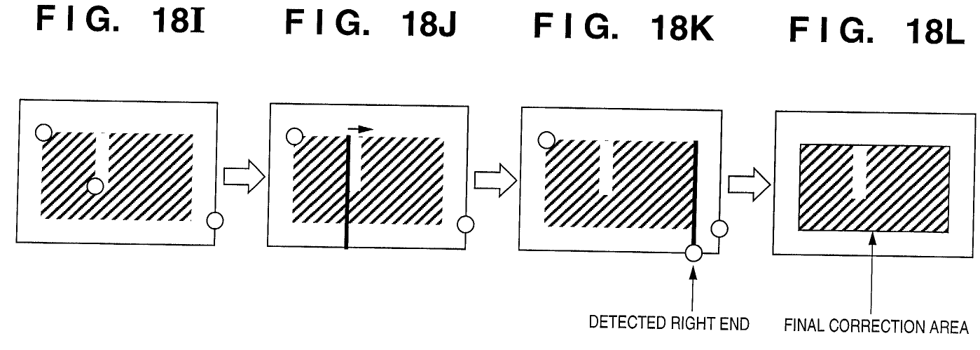

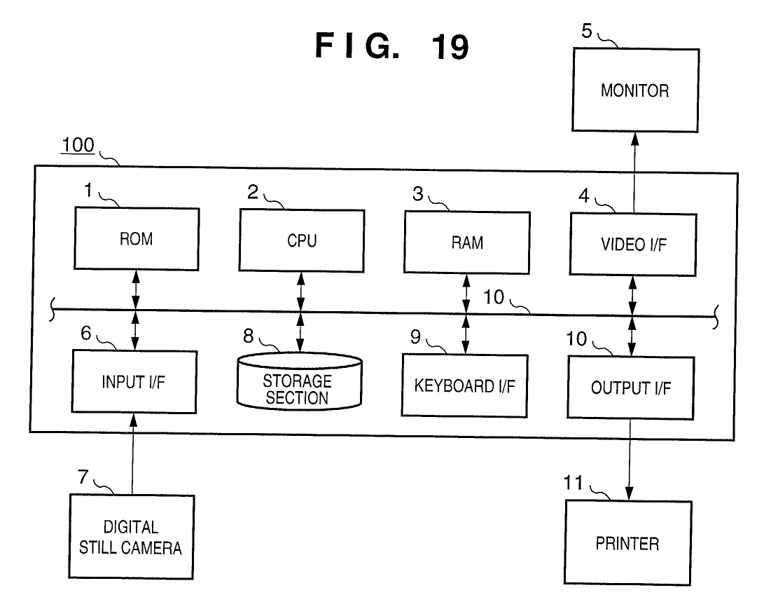

FIGS. 18A to 18L are views for explaining image recognition. In FIGS. 18A to 18L, an image portion represented by data stored in the image information holding section 9 after execution of step S62 has a U shape due to some reason. The original image portion has, e.g., a rectangular photographic image.

First, in step S71, the left end of the image is detected (FIGS. 18A and 18B). In step S73, the upper end of the image is detected (FIGS. 18C and 18D). In step S75, the right end of the image is detected (FIGS. 18E and 18F). In step S76, the position of the right end is compared with that of the lower end. Since the lower end is on the left side of the right end, the flow advances to step S77.

In step S77, the lower end of the image is detected (FIGS. 18G and 18H). In step S76, again, the position of the right end and that of the lower end are compared. Since the right end is on the upper side of the lower end, the flow returns to step S75.

In step S75, the right end of the image is detected (FIGS. 18J and 18K). In step S76, again, the position of the right end is compared with that of the lower end. Since the right end is on the lower left side of the lower end, the image portion is determined, and the flow advances to step S64.

As described above, according to the above-described embodiments, since an image containing a frame image is subjected to gradation correction excluding the frame image, the gradation can be appropriately corrected without any influence of the color or luminance of the frame image. In addition, a frame image with gradation can also be recognized using a similar algorithm. Furthermore, with application of this algorithm, even when an image contains a plurality of images such as photographs separated by frame images, appropriate gradation correction can be performed for each image.

[Terms: Left End, Upper End, Right End, and Lower End]

In the above description of embodiments, the left, upper, right, and lower ends of an image are detected. More exactly, the coordinates of positions indicated by hollow bullets in FIGS. 17A to 18H are detected, and these positions are compared with each other. For example, a right end or lower end means the coordinates of a position where a line corresponding to the right end of an image portion crosses the contour of the entire image or the contour of the image portion.

As has been described below, according to the present invention, an image containing a frame image can be appropriately processed.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus comprising:
detection means for detecting an image area excluding a frame image contained in an input image;
generation means for generating correction information of the detected image area; and
correction means for correcting the image area on the basis of the generated correction information.

2. The apparatus according to claim 1, wherein when pixels adjacent to a pixel of interest satisfy a predetermined condition, said detection means determines that the pixel of interest constructs the frame image.

3. The apparatus according to claim 2, wherein said detection means identifies the image area other than the frame image on the basis of a detection result of the pixel constructing the frame image and supplies information representing the identified image area to said generation means and said correction means.

4. The apparatus according to claim 3, wherein said detection means scans the image in a horizontal direction in units of columns and detects, as two ends of the image area in the horizontal direction, a first column having a pixel determined not to construct the frame image and the next column having a pixel determined to construct the frame image.

5. The apparatus according to claim 3, wherein said detection means scans the image in a vertical direction in units of rows and detects, as two ends of the image area in the vertical direction, a first row having a pixel determined not to construct the frame image and the next row having a pixel determined to construct the frame image.

6. The apparatus according to claim 3, wherein after correction by said correction means is ended, said detection means executes identification processing of an image area other than the frame image again.

7. The apparatus according to claim 1, wherein said generation means generates, as the correction information, highlight and shadow points and white and black balances of the image area.

8. The apparatus according to claim 7, wherein said correction means corrects gradation of the image area on the basis of the highlight and shadow points and the white and black balances, which are generated by said generation means.

9. An image processing method comprising the steps of:
detecting an image area excluding a frame image contained in an input image;
generating correction information of the detected image area; and
correcting the image area on the basis of the generated correction information.

10. The method according to claim 9, wherein the detection step comprises, when pixels adjacent to a pixel of interest satisfy a predetermined condition, determining that the pixel of interest constructs the frame image.

11. The method according to claim 10, further comprising the steps of:
identifying the image area other than the frame image on the basis of a detection result of the pixel constructing the frame image; and
supplying information representing the identified image area for generation processing of the correction information and correction processing of the image area.

12. The method according to claim 11, wherein the detection step comprises scanning the image in a horizontal direction in units of columns and detecting, as two ends of the image area in the horizontal direction, a first column having a pixel determined not to construct the frame image and the next column having a pixel determined to construct the frame image.

13. The method according to claim 11, wherein the detection step comprises scanning the image in a vertical direction in units of rows and detecting, as two ends of the image area in the vertical direction, a first row having a pixel determined not to construct the frame image and the next row having a pixel determined to construct the frame image.

14. The method according to claim 11, wherein after correction processing is ended, identification processing of an image area other than the frame image is executed again.

15. The method according to claim 9, wherein the generation step comprises generating, as the correction information, highlight and shadow points and white and black balances of the image area.

16. The method according to claim 15, wherein the correction step comprises correcting gradation of the image area on the basis of the highlight and shadow points and the white and black balances, which are generated in the generation step.

17. A computer program product comprising a computer readable medium having computer program code, for executing image processing, said product comprising:
detecting procedure code for detecting an image area excluding a frame image contained in an input image;
generating procedure code for generating correction information of the detected image area; and
correcting procedure code for correcting the image area on the basis of the generated correction information.
